(19) United States
(12) Patent Application Publication
(10) Pub. No.: US 2010/0037306 A1
(43) Pub. Date: Feb. 11, 2010

(54) ELECTRONIC DEVICE AND ACCESS CONTROL METHOD THEREOF

(75) Inventor: HSIAO-SHUN JAN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/491,257

(22) Filed: Jun. 25, 2009

(30) Foreign Application Priority Data
Aug. 6, 2008 (CN) 200810303556.2

(51) Int. Cl. H04L 9/32; G06F 21/00

(52) U.S. Cl. 726/7; 345/173

(57) ABSTRACT

An electronic device and an access control method include selecting a login image, determining and constructing a coordinate system for a touch panel of the electronic device, and recording coordinates of a first group of touch points on the login image and a first touch sequence correspondingly. The electronic device and the access control method further include confirming a touchable area corresponding to each touch point of the first group of touch points and a preset error range, and storing the login image and the touchable areas into a storage system of the electronic device.

### BACKGROUND

1. Technical Field

Embodiments of the present disclosure relate to electronic devices and methods for access controlling, and more particularly to an electronic device and method for access controlling by using a login image.

2. Description of Related Art

Multifunctional and large-volume electronic devices, such as mobile phones have been developed and widely used. These electronic devices have storage devices for storing various kinds of information, such as an address book, mail, transmission/reception history, messages, photographs, digital videos, and so on. In case that the electronic devices are lost, the information that should not be leaked out might often leak out. Since such information contains personal information of users, the personal information may be confidential. Leakage of such personal information may result in many problems.

What is needed, therefore, is an improved electronic device and method for controlling access of an electronic device, so as to protect personal information.

### BRIEF DESCRIPTION OF THE DRAWINGS

FIG. 1 is a block diagram of one embodiment of an electronic device capable of access control.

FIG. 2 is a diagram of one embodiment of a login image to be set a password.

FIG. 3 is a flowchart of one embodiment of a method for setting passwords.

FIG. 4 is a flowchart of one embodiment of a method of access control.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

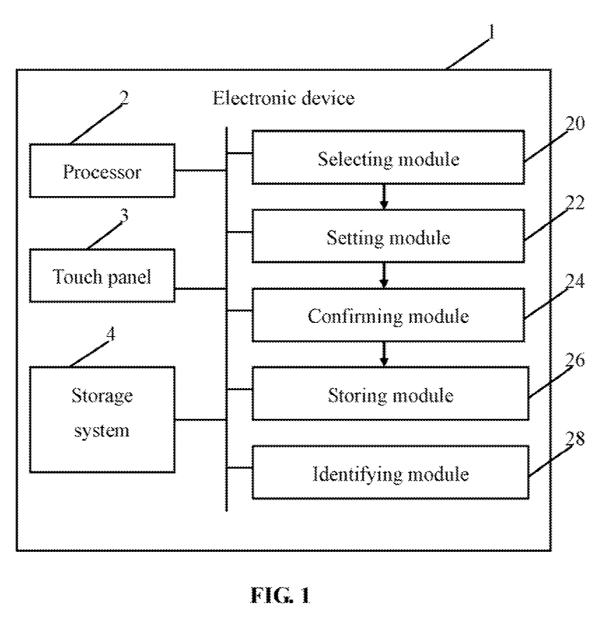

FIG. 1 is a block diagram of one embodiment of an electronic device 1 capable of access control. In one embodiment, the electronic device 1 includes a processor 2, a touch panel 3, and a storage system 4. The processor 2 executes programs of the electronic device 1 and the other applications, to provide functions of the electronic device 1. In one embodiment, the touch panel 3 may be a liquid crystal display (LCD) touch panel. Depending on the embodiment, the touch panel 3 may provide a display interface to display images, messages or other visual data, a virtual button interface including functions buttons, such as direction keys, a “cancel” button, a “confirm” button, for example.

The storage system 4 stores one or more programs, such as programs of an operating system, and other applications of the electronic device 1, and various kinds of data, such as images, messages, etc. In one embodiment, the electronic device 1 may be a desktop computer, a notebook computer, a mobile phone, a personal digital assistant (PDA), or any other kind of computing device. The storage system 4 may include a memory of the electronic device 1 (e.g., a hard disk, etc.) or an external storage card, such as a memory stick, a smart media card, a compact flash card, or any other type of memory card.

The storage system 4 includes a selecting module 20, a setting module 22, a confirming module 24, a storing module 26, and an identifying module 28. The modules 20, 22, 24, 26, and 28 may comprise one or more computerized operations used to execute one or more operations of the electronic device 1, such as setting a password by using a login image stored in the storage system 4.

The selecting module 20 selects a login image from the storage system 4, and displays the login image on the display interface of the touch panel 3.

The setting module 22 determines and constructs a coordinate system for the display interface.

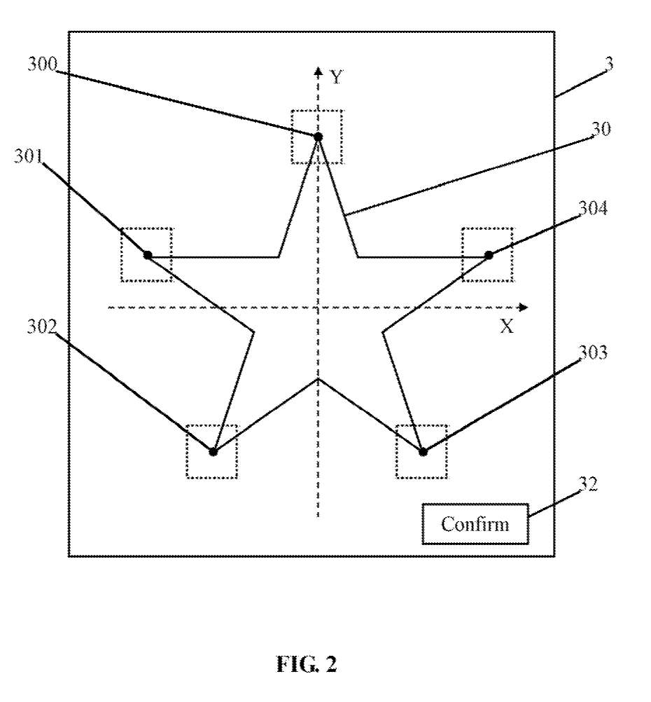

The confirming module 24 receives a first group of touch signals from the touch panel 3 in response to touch actions of a user, confirms a first group of touch points on the login image according to the first group of touch signals, and records coordinates of the first group of touch points according to a first touch sequence of the first group of touch signals. In one embodiment, as shown in FIG. 2, a login image 30 is displayed on the touch panel 3, and the first group of touch points are 300, 301, 302, 303, and 304 sequentially. The “confirm” button on the virtual button interface of the touch panel 3 may be tapped/touched by a finger of the user or a stylus, to confirm input of the first group of touch points. Depending on the embodiment, the touch actions of the user are regarded as password input actions.

The setting module 22 further sets an error range for the first group of touch points. The confirming module 24 confirms a touchable area corresponding to each touch point in the first group of touch points according to the coordinates of the first group of touch points and the error range. The touchable area is a circle or a square, whose center is a corresponding touch point in the first group of touch points. In one embodiment, coordinates of a touch point 300 (shown in FIG. 2) in the first group of touch points are (x, y), and the error range is 5 mm. A touchable area corresponding to the touch point 300 is confirmed as a square formed by dotted lines. The center of the touchable area is the touch point 300, and coordinates of four vertexes of the touchable area are (x−2, y+2), (x−2, y−2), (x+2, y−2), and (x+2, y+2). In another embodiment, the touchable area corresponding to the touch point 300 may be a circle, whose center is the touch point 300 and radius is 5 mm as the error range.

The storing module 26 stores the login image, the coordinates of the first group of touch points, the error range, and the touchable area corresponding to each touch point in the first group of touch points into the storage system 4, thereby the password for logging into the electronic device 1 is set.

The selecting module 20 also loads the login image before granting access to the electronic device 1, and displays the login image on the display interface. The user may select a second group of touch points on the login image through the touch panel 3, and press the “confirm” button after finishing selecting the second group of touch points. The confirming module 24 acquires coordinates of the second group of touch points on the login image in response to receiving a second group of touch signals from the touch panel 3, and acquires a second touch sequence of the second group of touch signals.

The identifying module 28 identifies if each touch point in the second group of touch points is within a corresponding touchable area according to the coordinates of the second group of touch points, and identifies if the second touch sequence matches the first touch sequence. If each touch point in the second group of touch points is within a corresponding touchable area and the second touch sequence matches the first touch sequence, the identifying module 28 grants access to the electronic device 1. If any touch point in the second group of touch points is not within a corresponding touchable area or the second touch sequence does not match the first touch sequence, the identifying module 28 denies access to the electronic device 1.

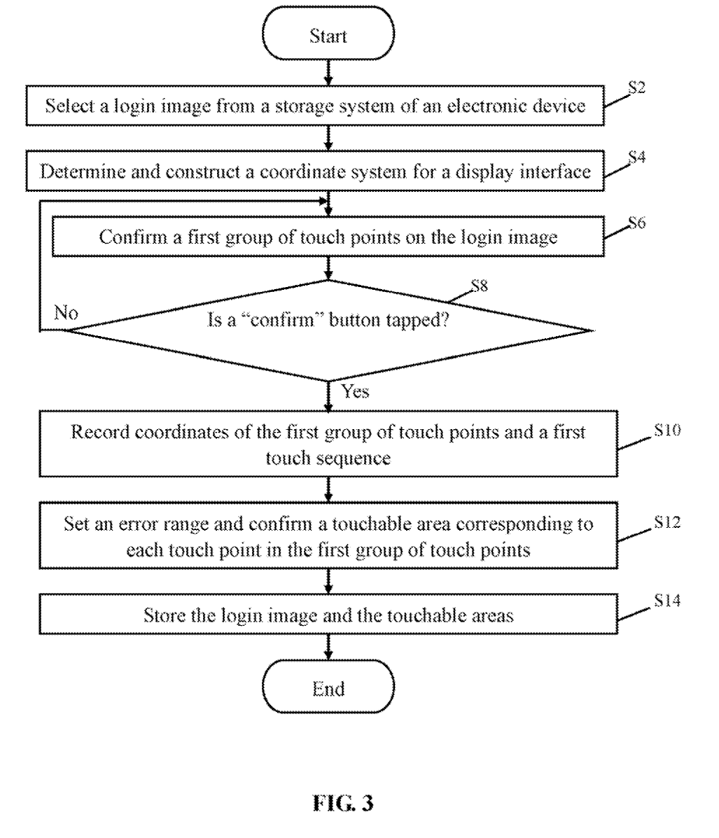

FIG. 3 is a flowchart of one embodiment of a method for setting passwords. Depending on the embodiment, additional blocks may be added, others removed, and the ordering of the blocks may be replaced.

For the purpose of describing the flowchart distinctly, it is supposed that the electronic device 1 does not have any previous set access/login password before. In block S2, the selecting module 20 selects a login image from a storage system 4 in the electronic device 1 and displays the login image on a display interface of a touch panel 3 of the electronic device 1.

In block S4, the setting module 22 determines and constructs a coordinate system for the display interface.

In block S6, the confirming module 24 receives a first group of touch signals from the touch panel 3 in response to touch actions of a user, and confirms a first group of touch points on the login image according to the first group of touch signals.

In block S8, the confirming module 24 determines if a “confirm” button on the virtual button interface of the touch panel 3 is tapped. If the “confirm” button is tapped, in block S10, the confirming module 24 records coordinates of the first group of touch points according to a first touch sequence of the first group of touch signals. If the “confirm” button is not tapped, the procedure returns to the block S6.

In block S12, the setting module 22 sets an error range for the first group of touch points, and the confirming module 24 confirms a touchable area corresponding to each touch point in the first group of touch points according to the coordinates of the first group of touch points and the error range. As mentioned above, the touchable area is a circle or a square, whose center is a corresponding touch point in the first group of touch points.

In block S14, the storing module 26 stores the login image, the coordinates of the first group of touch points, the error range, and the touchable area corresponding to each touch point in the first group of touch points into the storage system 4.

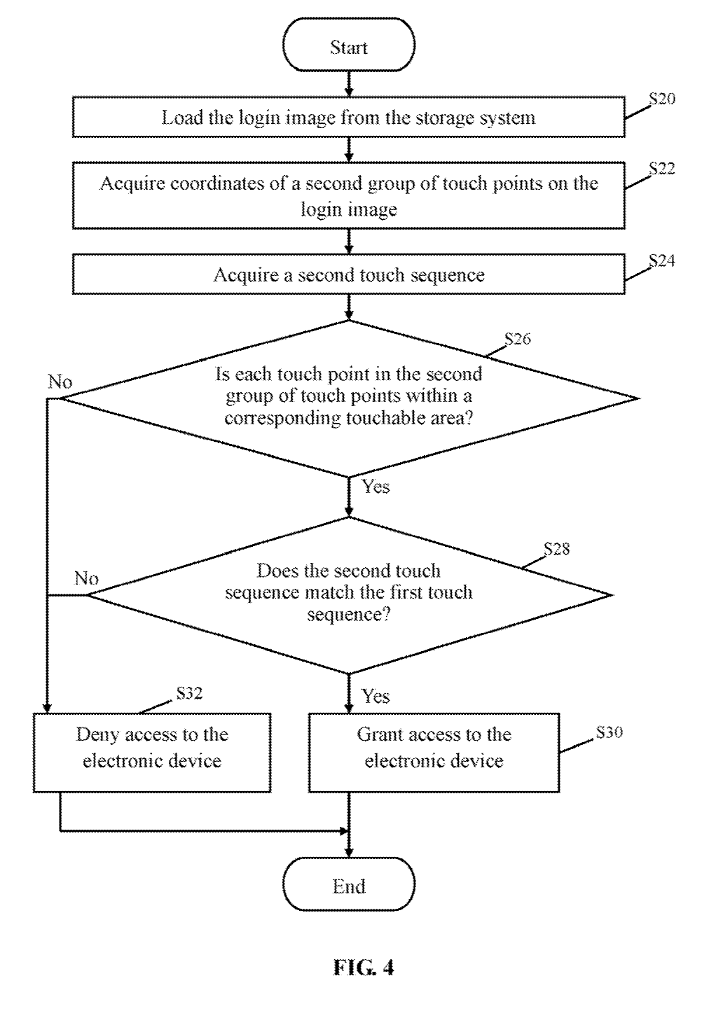

FIG. 4 is a flowchart of one embodiment of a method of access control. Depending on the embodiment, additional blocks may be added, others removed, and the ordering of the blocks may be replaced.

In block S20, the selecting module 20 loads the login image before granting access to the electronic device 1, and displays the login image on the display interface. A second group of touch points on the login image need to be selected by tapped/touched on the login image so as to perform a login procedure, and the “confirm” button is tapped after performing the login procedure.

In block S22, the confirming module 24 acquires coordinates of the second group of touch points on the login image in response to receiving a second group of touch signals from the touch panel 3.

In block S24, the confirming module 24 acquires a second touch sequence of the second group of touch signals.

In block S26, the identifying module 28 identifies if each touch point in the second group of touch points is within a touchable area according to the coordinates of the second group of touch points. If each touch point in the second group of touch points is within a corresponding touchable area, in block S28, the identifying module 28 identifies if the second touch sequence matches the first touch sequence. Otherwise, if one or more touch points in the second group of touch points are not within a corresponding touchable area, the procedure goes to block S32 directly.

If the second touch sequence matches the first touch sequence, in block S30, the identifying module 28 grants access to the electronic device 1. If the second touch sequence does not match the first touch sequence, the procedure goes to block S32 directly.

In block S32, the identifying module 28 denies access to the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An access control method of an electronic device, the electronic device including a touch panel and a storage system, the method comprising:
selecting a login image from the storage system, and displaying the login image on a display interface of the touch panel;
determining and constructing a coordinate system for the display interface;
confirming a first group of touch points on the login image in response to receiving a first group of touch signals from the touch panel;
recording coordinates of the first group of touch points according to a first touch sequence of the first group of touch signals;
setting an error range for the first group of touch points, and confirming a touchable area corresponding to each touch point in the first group of touch points according to the coordinates of the first group of touch points and the error range; and
storing the login image and the touchable areas into the storage system.

2. The method according to claim 1, further comprising:
loading the login image before granting access to the electronic device, and displaying the login image on the display interface;
acquiring coordinates of a second group of touch points on the login image in response to receiving a second group of touch signals from the touch panel, and acquiring a second touch sequence of the second group of touch signals;
identifying if each touch point in the second group of touch points is within a corresponding touchable area according to the coordinates of the second group of touch points, and identifying if the second touch sequence matches the first touch sequence; and
granting access to the electronic device if each touch point in the second group of touch points is within a corresponding touchable area and the second touch sequence matches the first touch sequence.

3. The method according to claim 2, further comprising:
denying access to the electronic device if a touch point in the second group of touch points is not within a corresponding touchable area or the second touch sequence does not match the first touch sequence.

4. The method according to claim 1, wherein the display interface provides a confirm button for confirming input of the first group of touch points and/or the second group of touch points.

5. The method according to claim 1, wherein the touchable area is a circle or a square, whose center is a corresponding touch point in the first group of touch points.

6. An electronic device, comprising:
a touch panel;
a storage system;
at least one processor; and
one or more programs stored in the storage system and being executable by the at least one processor, the one or more programs comprising:
a selecting module operable to select a login image from the storage system, and display the login image on a display interface of the touch panel;
a setting module operable to determine and construct a coordinate system for the display interface, and set an error range for the first group of touch points;
a confirming module operable to confirm a first group of touch points on the login image in response to receiving a first group of touch signals from the touch panel, record coordinates of the first group of touch points according to a first touch sequence of the first group of touch signals, and confirm a touchable area corresponding to each touch point in the first group of touch points according to the coordinates of the first group of touch points and the error range; and
a storing module operable to store the login image and the touchable areas into the storage system.

7. The electronic device according to claim 6, wherein the selecting module is further operable to load the login image before granting access to the electronic device, and displays the login image on the display interface; and
the confirming module is further operable to acquire coordinates of a second group of touch points on the login image in response to receiving a second group of touch signal from the touch panel, and acquire a second touch sequence of the second group of touch signals.

8. The electronic device according to claim 7, wherein the one or more programs further comprise an identifying module operable to identify if each touch point in the second group of touch points is within a corresponding touchable area according to the coordinates of the second group of touch points, and identify if the second touch sequence matches the first touch sequence, grant access to the electronic device if each touch point in the second group of touch points is within a corresponding touchable area and the second touch sequence matches the first touch sequence, or deny access to the electronic device if a touch point in the second group of touch points is not within a corresponding touchable area or the second touch sequence does not match the first touch sequence.

9. The electronic device according to claim 6, wherein the display interface provides a confirm button for confirming input of the first group of touch points and/or the second group of touch points.

10. The electronic device according to claim 6, wherein the touchable area is a circle or a square, whose center is a corresponding touch point in the first group of touch points.

11. A storage medium storing a set of instructions, the set of instructions capable of being executed by a processor to perform an access control method of an electronic device, the method comprising:
selecting a login image from a storage system of the electronic device, and displaying the login image on a display interface of a touch panel of the electronic device;
determining and constructing a coordinate system for the display interface;
confirming a first group of touch points on the login image in response to receiving a first group of touch signals from the touch panel;
recording coordinates of the first group of touch points according to a first touch sequence of the first group of touch signals;
setting an error range for the first group of touch points, and confirming a touchable area corresponding to each touch point in the first group of touch points; and
storing the login image and the touchable areas into the storage system.

12. The storage medium as claimed in claim 11, wherein the method further comprises:
loading the login image before granting access to the electronic device, and displaying the login image on the display interface;
acquiring coordinates of a second group of touch points on the login image in response to receiving a second group of touch signals from the touch panel, and acquiring a second touch sequence of the second group of touch signals;
identifying if each touch point in the second group of touch points is within a corresponding touchable area according to the coordinates of the second group of touch points, and identifying if the second touch sequence matches the first touch sequence; and
granting access to the electronic device if each touch point in the second group of touch points is within a corresponding touchable area and the second touch sequence matches the first touch sequence.

13. The storage medium as claimed in claim 12, wherein the method further comprises:
denying access to the electronic device if a touch point in the second group of touch points is not within a corresponding touchable area or the second touch sequence does not match the first touch sequence.

14. The storage medium as claimed in claim 11, wherein the display interface provides a confirm button for confirming input of the first group of touch points and/or the second group of touch points.

15. The storage medium as claimed in claim 11, wherein the touchable area is a circle or a square, whose center is a corresponding touch point in the first group of touch points.
